(19) United States
(12) Patent Application Publication
(10) Pub. No.: US 2004/0071987 A1
(43) Pub. Date: Apr. 15, 2004

(54) Non-stick coating and method of forming same

(76) Inventor: Thomas J. Bate, Glenview, IL (US)

Correspondence Address: BRINKS HOFER GILSON & LIONE, P.O. BOX 10395, CHICAGO, IL, 60611, US

(21) Appl. No.: 10/613,748

(22) Filed: Jul. 2, 2003

Related U.S. Application Data
(60) Provisional application No. 60/393,257, filed on Jul. 2, 2002.

(51) Int. Cl. B05D 1/36

(52) U.S. Cl. 428/447; 427/402; 427/553; 427/407.1

(57) ABSTRACT

Non-stick coatings for use on a substrate are provided. The coatings include at least one coat that contains a binder component and a fluoropolymer component. The at least one coat may be the sole coating for use on the substrate or it may form a part of a multi-coat composition. That is, the non-stick coating may include a primer coat, an intermediate coat, and a top coat.

### BACKGROUND OF THE INVENTION

This application claims priority to Provisional Application No. 60/393,257 filed on Jul. 2, 2002.

It is sometimes desirable to coat a flexible surface with a non-stick coating. Traditional coatings that are used on rigid surfaces (e.g. cookware) are unacceptable because they are unable to bend and flex along with the flexible surface. A specific application in which this problem has arisen concerns pressure rollers for printing machines.

Modern printing machines generally contain a heated fuser roller and an opposing pressure roller. As paper is fed between the rollers, the heated fuser roller melts (i.e., fuses) toner onto the paper to form the desired image. The pressure roller applies sufficient pressure to the paper to allow it to touch the fuser roller and have the image applied to it. The pressure roller typically consists of a steel or aluminum core that is coated with some type of rubber. The rubber on the pressure roller is flexible so that it can bend and adapt to the topographical features of the fuser roller and paper. The higher the quality of the image desired, and the faster the printing rate of the printer or copier, the softer the rubber on the pressure roller must be so that the ink does not smudge when it melts. The rubber in modern high quality, high speed printers is commonly a very low durometer silicone rubber.

It is desirable to apply a non-stick coating to the pressure rollers to protect the soft rubber from chemical and thermal degradation, as well as to prevent the paper and ink from sticking to the roller. Applying a non-stick coating to such soft rubber, however, presents a number of problems. First, it is difficult for conventional non-stick coatings to stick to this very soft silicone rubber because the non-stick coating must be able to bend and flex with the silicone rubber that it coats. If the non-stick coating is not sufficiently flexible, it will crack and/or peel away from the pressure roller during use. This decreases the print quality of the resultant image. Second, conventional non-stick coatings are relatively hard when compared to the soft silicone rubbers used on pressure rollers. As a result, the non-stick coatings increase the effective durometer of the pressure roller and decrease the conformability of the roller. This is counterproductive to the goal of a very soft pressure roller that produces a high quality image.

Prior attempts at a non-stick coating for a pressure roller include the application of a fluoropolymer sleeve over the roller surface. Problems with prior art fluoropolymer sleeves, however, include an unacceptable increase in the effective durometer of the pressure roller and a high rate of delaminating due to shear stresses between the fluoropolymer sleeve and the rubber roller. When a sleeve wears out (i.e., delaminates), it peels away from the pressure roller and becomes wrinkled. The wrinkled pressure roller creates very poor quality images and must be replaced at great expense. For this reason, there is a need for a non-stick coating that can be used on a flexible surface, yet is durable, functional, and low-cost.

### BRIEF SUMMARY OF THE INVENTION

The coating of the present invention includes at least one coating that comprises a binder component and a fluoropolymer component. In a first embodiment, a non-stick coating includes at least one coat. The coat includes a silane, a binder component, and a fluoropolymer component. The weight ratio of the binder component to the fluoropolymer component is preferably about 1:4.

In a second embodiment, a non-stick coating includes a primer coat, an intermediate coat, and a top coat. The intermediate coat includes a binder component and a fluoropolymer component, wherein the weight ratio of the binder component to the fluoropolymer component is about 7:3. The top coat includes a fluoropolymer.

The present invention is also directed to methods of applying the coatings to substrates and curing the coatings with infrared radiation. Preferably, the coatings are applied to flexible substrates such as soft rubber substrates.

### DETAILED DESCRIPTION OF THE INVENTION

The non-stick coating of the present invention may be used to coat a substrate of any desired hardness. The type of substrate to which the coating is applied does not limit the scope of the invention. The coating of the present invention may be used on rigid surfaces (e.g., cookware), though it is preferably used to coat a flexible surface. A “flexible surface” is any surface that deforms, bends, flexes or changes shape when subjected to an external force or pressure. Most preferably, the non-stick coating of the present invention is used to coat a soft rubber pressure roller for use in a printing machine, such as a high-speed digital copier or printer. Non-limiting examples of the soft rubbers that may be coated with the non-stick coating of the present invention are silicone rubber, EPDM rubber (ethylene propylene rubber), and neoprene.

The non-stick coatings of the present invention may be applied to a substrate in a one-coat process or a multi-coat process. Preferably, the coating is applied in a three-coat process, wherein the three coats are a primer coat, an intermediate coat, and a top coat. The three-coat process results in a coating that is more durable and has better release properties than the one-coat process, however, it is also more expensive.

The non-stick coatings of the present invention contain one or more binder components, one or more fluoropolymer components and in some embodiments, a silane component which contains one or more reactive functional groups.

The binder component facilitates adhesion of the coating to the substrate and helps strengthen the film. The binder of the present invention is preferably soluble in water or a mixture of water and organic solvent. The preferred binder is polyethersulfone (PES). The preferred PES is commercially available from of Gharda Chemicals Limited and sold under the trade name GAFONE 3400.

Non-limiting examples of other acceptable binders are polyamideimide (PAI), polyarylsulfone (PAS) and polyphenylene sulfide (PPS). A PAI dispersion may be added directly to the coating formulation, or, alternatively, a polyamic acid salt may be added to the formulation wherein the salt converts to PAI upon curing of the coating.

The binder component may consist of one binder or a mixture or blend of more than one binder. Non-limiting examples of possible binder combinations are PAI/PPS, PES/PPS, PAI/PAS and PAI/PES.

The fluoropolymer component is responsible for the non-stick quality of the coating. There are myriad commercially available fluoropolymers and the specific fluoropolymer chosen does not limit the scope of the present invention. The fluoropolymer component of the present invention may consist of a single type of fluoropolymer, or may consist of a mixture or blend of more than one type of fluoropolymer.

The preferred fluoropolymers are tetrafluoroethylene-perfluoromethyl vinyl ether copolymer (MFA), tetrafluoroethylene-hexafluoropropylene copolymer (FEP), and polytetrafluoroethylene (PTFE). MFA is the most preferred fluoropolymer. The preferred MFA is commercially available from Ausimont and sold under the trade name HYFLON® MFA. The preferred FEP is commercially available from Dyneon and sold under the trade name DYNEON™ FLUOROTHERMOPLASTIC FEP X 6300, and the preferred PTFE is commercially available from Asahi Glass and sold under the trade name FLUON® AD1.

Non-limiting examples of other acceptable fluoropolymers are polytetrafluoroethylene micropowder, polychloro-trifluoroethylene (PCTFE), ethylene-chlorotrifluoroethylene copolymer (ECTFE), ethylene-tetrafluoroethylene copolymer (ETFE), tetrafluoroethylene (TFE) and perfluoro (ethyl vinyl ether) (PEVE) copolymer (PFA), TFE and perfluoro (propyl vinyl ether) (PPVE) copolymer (PFA), polyvinylfluoride (PVF), and polyvinylidene fluoride (PVDF). The fluoropolymer component may also include comonomer modifiers that improve selected characteristics.

The fluoropolymer component is preferably a dispersion of the fluoropolymer in water. By “dispersion” it is meant that the fluoropolymers particles are stably dispersed in water, so that the particles do not settle before the dispersion is used. In some cases it may be desirable to include an organic solvent, such as n-methylpyrrolidone, butyrolactone, high boiling aromatic solvents, alcohols, or mixtures thereof.

As noted above, in some embodiments of the present invention, a silane component is added to the coating. Preferred silanes include vinyltrimethoxysilane, gamma-methacycloxypropyltrimethoxy silane, vinyltris (t-butylperoxy) silane and partially hydrolyzed silanes. The most preferred silane is X33-156-5 and is commercially available from Shin-Etsu Chemical Co.

The non-stick coating of the present invention may consist of one or more coats. The preferred one-coat system comprises a binder component and a fluoropolymer component in a weight ratio of about 1:4. (Unless otherwise stated, all ratios and percentages stated herein are by weight). The one-coat formulation may also be used as one of the layers (e.g. the primer layer) in a multi-coat system.

Following is a specific example of a one-coat formulation. The composition is comprised of approximately 45% MFA perfluoropolymer dispersion (54% solids in water), approximately 6% PES dispersion (8% powder dispersed in water), approximately 12% n-methyl pyrolidone, approximately 1% of a reactive silane, and carbon black pigment. Preferably, the PES binder is GAFONE 3400 which is commercially available from Gharda Chemicals Limited and the MFA fluoropolymer is HYFLON® MFA which is commercially available from Ausimont. The preferred silane is X33156-5 which is commercially available from Shin-Etsu Chemical Co.

The balance of the formulation is water and additives. Each individual additive comprises less than 2% of the composition. The additives consist of well known defoamers, flow agents, dispersants, surfactants, stabilizers, thickeners and/or fillers.

The one-coat formulation is preferably filtered through a mesh filter rated at 150 microns and sprayed onto the substrate by conventional or high volume, low pressure (HVLP) methods. The preferred thickness of the dry coat is from about 10 to about 20 microns.

The coating is preferably cured for about one to two minutes in a short wave infrared oven operating at approximately 0.76-2 μm. Preferably, the surface temperature of the coating is maintained at approximately 400-425° F. The silicone rubber that is commonly used to coat pressure rollers begins to thermally decompose at about 500-550° F. Thus, it is desirable to cure the coating in such a manner that the temperature of the silicone rubber stays below 500° F. Curing in a low-frequency (long wave length) infrared oven helps keep the temperature of the substrate below this decomposition temperature. If the frequency of infrared radiation is too great, the non-stick coating may crack during the curing process. If the frequency is too low (wavelength is too long) there is not enough energy to effect a cure of the coating. The use of black pigment in the coating, preferably carbon black, facilitates absorption of the infrared radiation and curing of the coating before the temperature of the substrate reaches 500° F.

In an alternative embodiment, the non-stick coating of the present invention is applied in a three-coat process. The first coat is a primer that helps bond a subsequent fluoropolymer containing layer to the substrate. Any primer that bonds effectively to the chosen substrate is acceptable. Where the substrate consists of silicone rubber or other rubber having a hydroxy functional group (such as EPDM rubber), the primer is preferably a silane primer. Preferred silane primers include vinyltrimethoxysilane, gammamethacycloxypropyl-trimethoxy silane, vinyltris (t-butylperoxy) silane and partially hydrolyzed silanes. The most preferred silane primer is commercially available from Shin-Etsu under the trade name X33-156-S. This preferred primer is effective on at least silicone rubber and/or EPDM rubbers having a durometer of between 5 and 40. An alternative primer is SYLGARD, made by Dow Corning. Preferably, the primer component consists of only one type of primer, however, different primers may be mixed or combined to form the binder component. In one embodiment, the primer coat may be the same as the one-coat formulation described above. The primer is preferably applied in a very thin layer having a thickness of between one molecule to just a few microns. The primer may be applied by wiping it on the substrate with a cloth or by conventional or HVLP spray guns. The applied primer is typically very volatile and may be dried by any means desirable, though it is preferably dried in a conventional oven at 150° F. for about 3-5 minutes or at air temperature (−77° F.) for fifteen minutes.

The intermediate coat of a three-coat system comprises a binder component and a fluoropolymer component in a ratio of about 7:3. More preferably, the fluoropolymer component is a combination of FEP and PTFE in a ratio of 91:9. It is also preferred to include a black pigment, such as carbon black, in the intermediate coat to aid absorption of infrared radiation during the curing process. In a preferred embodiment, the intermediate coat comprises approximately 31% FEP dispersion (50% in water), 3% PTFE dispersion (60% in water), 8% PES dispersion (8% in water), 15% n-methyl pyrolidone, and carbon black pigment. Preferably, the FEP dispersion is DYNEON™ FLUOROTHERMOPLASTIC FEP X 6300 which is commercially available from Dyneon, the PTFE dispersion is preferably FLUON® AD1 which is commercially available from Asahi Glass Fluoropolymers USA, Inc., and the PES is preferably GAFONE 3400 which is commercially available from Gharda Chemicals Limited.

The balance of the formulation is water and additives. Each individual additive comprises less than 2% of the composition. The additives consist of well known defoamers, flow agents, dispersants, surfactants, stabilizers, thickeners and/or fillers.

The preferred thickness of the intermediate coat varies according to the hardness of the substrate. If the durometer of the substrate is less than 10, the thickness of the intermediate coat is preferably less than 5 microns. (Unless otherwise stated, all references to durometer are based on the Shore A scale). If the durometer of the substrate is between 10 and 20, the thickness of the intermediate coat is preferably less than 7 microns. If the durometer of the substrate is greater than 20, the thickness of the intermediate coat is preferably greater than 10 microns, most preferably about 12-15 microns. The intermediate coat is preferably sprayed directly on top of the dried primer and the article is cured in a conventional oven at 150-250° F. for 2-3 minutes.

The principal component(s) of the top coat of the three-coat system is one or more fluoropolymer dispersions. In one embodiment, the top coat comprises approximately 67% of an MFA dispersion (54% in water), 12% of an FEP dispersion (50% in water), 11% of an acrylic resin (44% in water), and 7% of propylene glycol solvent. The MFA dispersion is XPH1 which is commercially available from Asahi Glass Fluoropolymers USA, Inc., the FEP dispersion is DYNEON™ FLUOROTHERMOPLASTIC FEP X 6300 which is commercially available from Dyneon, and the acrylic resin is JONCRYL 1540 which is commercially available from Johnson Polymer. The balance of the formulation is water and additives. Each individual additive comprises less than 2% of the composition. The additives consist of well known defoamers, flow agents, dispersants, surfactants, stabilizers, thickeners and/or fillers.

The thickness of the top coat varies according to the hardness of the substrate. If the durometer of the substrate is less than 10, the thickness of the top coat is approximately 7 microns. If the durometer of the substrate is between 10 and 20, the thickness of the top coat is about 9 microns. If the durometer of the substrate is greater than 20, then the top coat may be as thick as is desirable, but is preferably approximately 15 microns. The top coat is preferably sprayed directly on the dried intermediate coat by conventional or HVLP guns. The substrate with all three coats is then cured for 1-3 minutes in an IR oven operating at 0.76-2 μm. The temperature of the substrate is preferably maintained at between about 400° F. and about 450° F.

Any of the coatings described herein can be made to be conductive. In high-speed copiers it is very easy for a large static charge to build up in the paper and compromise image quality. For this reason, it may be desirable to have a conductive coating that dissipates the static charge. The coatings discussed above may be made conductive by replacing the carbon black pigment with a conductive pigment. Preferably, the conductive pigment is KETJEN BLACK available from the Ketjen Black International Company. An alternative conductive pigment is VULCAN® XC72R available from Cabot Corporation.

Specific one-coat and three-coat embodiments are provided above, however, the number of coats employed does not limit the scope of the present invention. Non-stick coatings of the present invention may also consist of two-coats or four or more coats. For example, it may be desirable to use two different primers, resulting in a four coat system. In addition, it may be desirable to add an additional intermediate coat.

While particular embodiments of the present invention have been illustrated and described above, the present invention should not be limited to such examples and descriptions. It should be apparent that changes and modifications may be incorporated and embodied as part of the present invention within the scope of the following claims.

1. A non-stick coating comprising at least one-coat comprising:
a. a silane;
b. a binder component; and
c. a fluoropolymer component;
wherein the weight ratio of the binder component to the fluoropolymer component is about 1:4.

2. The non-stick coating of claim 1, wherein the binder component comprises PES and the fluoropolymer component comprises MFA.

3. The non-stick coating of claim 1, wherein the binder component comprises PAI and the fluoropolymer component comprises MFA.

4. The non-stick coating of claim 1, wherein the binder component comprises PES and the fluoropolymer component comprises PFA.

5. The non-stick coating of claim 1, wherein the binder component comprises PAI and the fluoropolymer component comprises PFA.

6. The non-stick coating of claim 1, wherein the one-coat is cured by infrared radiation.

7. The non-stick coating of claim 1, wherein the one-coat further includes a black pigment.

8. A conductive non-stick coating comprising at least one-coat, the one-coat comprising:
a. a silane;
b. a conductive pigment;
c. a binder component;
d. a fluoropolymer component; and
wherein the weight ratio of the binder component to the fluoropolymer component is about 1:4.

9. The non-stick coating of claim 8, wherein the binder component comprises PES and the fluoropolymer component comprises MFA.

10. The non-stick coating of claim 8, wherein the binder component comprises PAI and the fluoropolymer component comprises MFA.

11. The non-stick coating of claim 8, wherein the binder component comprises PES and the fluoropolymer component comprises PFA.

12. The non-stick coating of claim 8, wherein the binder component comprises PAI and the fluoropolymer component comprises PFA.

13. The non-stick coating of claim 8, wherein the one-coat is cured by infrared radiation.

14. The non-stick coating of claim 8, wherein the one-coat further includes a black pigment.

15. A non-stick coating comprising:
a. a primer coat;
b. an intermediate coat, the intermediate coat comprising a binder component and a fluoropolymer component, wherein the weight ratio of the binder component to the fluoropolymer component is about 7:3; and
c. a top coat, the top coat comprising a fluoropolymer.

16. The non-stick coating of claim 15, wherein the binder component is PES and the fluoropolymer component is a blend of FEP and PTFE.

17. The non-stick coating of claim 15, wherein the binder component is PES and the fluoropolymer component is MFA.

18. The non-stick coating of claim 15, wherein the primer coat comprises a silane.

19. A conductive non-stick coating formulation comprising:
a. a primer coat;
b. an intermediate coat, the intermediate coat comprising a conductive pigment, a binder component and a fluoropolymer component, wherein the weight ratio of the binder component to the fluoropolymer component is about 7:3; and
c. a top coat, the top coat comprising a fluoropolymer.

20. The non-stick coating of claim 19, wherein the binder component is PES and the fluoropolymer component is a blend of FEP and PTFE.

21. The non-stick coating of claim 19, wherein the binder component is selected from the group consisting of PES, PPS and PAI.

22. The non-stick coating of claim 19, wherein the fluoropolymer component is selected from the group consisting of MFA, PFA, FEP and PTFE.

23. A method of forming a non-stick coating, the method comprising the following steps:
a. applying a primer coat, the primer coat comprising a silane;
b. applying an intermediate coat, the intermediate coat comprising a binder component and a fluoropolymer component, wherein the weight ratio of the binder component to the fluoropolymer component is about 7:3;
c. applying a top coat; and
d. curing the applied coats with infrared radiation.

24. The method of claim 23 wherein the intermediate coat further comprises a conductive pigment.

25. The method of claim 23, wherein the coating is applied to a rubber substrate.

26. The method of claim 23, wherein the coating is applied to a silicone rubber substrate.

27. The method of claim 26, wherein the silicone rubber substrate has a durometer of less than 20.

28. The method of claim 26, wherein the silicone rubber substrate has a durometer of less than 10.

29. A method of forming a one-coat non-stick coating, the method comprising the following steps:
a. applying a coating comprising binder component and a fluoropolymer component, wherein the weight ratio of binder resin to fluoropolymer resin is about 1:4; and
b. curing the coating with infrared radiation.

30. The method of claim 29 wherein the intermediate coat further comprises a conductive pigment.

31. The method of claim 29, wherein the coating is applied to a rubber substrate.

32. The method of claim 29, wherein the coating is applied to a silicone rubber substrate.

33. The method of claim 32, wherein the silicone rubber substrate has a durometer of less than 20.

34. The method of claim 32, wherein the silicone rubber substrate has a durometer of less than 10.
